(19) United States
(12) Patent Application Publication
(10) Pub. No.: US 2023/0202446 A1
(43) Pub. Date: Jun. 29, 2023

(54) ACTUATOR ASSEMBLY

(71) Applicant: ZF Active Safety GmbH, Koblenz (DE)

(72) Inventors: Florian Kupp, Koblenz (DE); Peter Kohns, Vallendar (DE); Bogdan Draghici, Herschbach (DE); Gokula Kannan Krishnaswamy, Friedrichshafen (DE); Nikolas Thönnißen, Koblenz (DE); Hans Friedrich, Koblenz (DE)

(21) Appl. No.: 18/082,937

(22) Filed: Dec. 16, 2022

(30) Foreign Application Priority Data
Dec. 23, 2021 (DE) 102021134436.0

(51) Int. Cl. B60T 13/74; F16D 65/18

(52) U.S. Cl. CPC B60T 13/746; F16D 65/18; F16D 2121/24

(57) ABSTRACT

An actuator assembly for a vehicle brake is disclosed. The actuator assembly comprises, a carrier assembly, which comprises a first transmission plate and a second transmission plate, wherein the two transmission plates are connected to one another via a carrier component, are mounted in an actuator housing and carry a transmission unit. The first transmission plate has a fastening interface for an electric motor and is mounted in an elastically damped manner on the carrier component, and the second transmission plate is rigidly coupled to the carrier component.

### CROSS-REFERENCE TO RELATED APPLICATION

This application claims priority to German Priority Application No. 102021134436.0, filed Dec. 23, 2021, the disclosure of which is incorporated herein by reference in its entirety.

### TECHNICAL FIELD

The disclosure relates to an actuator assembly for a vehicle brake, in particular an electromechanical parking brake.

### BACKGROUND

As a rule, an actuator assembly of a vehicle brake comprises a mechanically movable brake piston, which brings about an application force on a wheel brake. In order to move the brake piston, an electric motor is provided which, for example, drives a spindle drive. For this purpose, the electric motor is coupled to the spindle drive via a transmission unit.

Since the electric motor causes drive noises during operation of the actuator assembly, that is to say during actuation and release of the vehicle brake, the actuator assembly is mounted in a damped manner, for example in the motor region. However, the damped mounting is disadvantageous in that the reaction forces which occur on the brake piston during braking act on the electric motor via the transmission unit, as a result of which the electric motor is subjected to increased loads, which can lead to faster wear of the electric motor.

### SUMMARY

What is needed is an actuator assembly by which adequate noise damping is possible while at the same time wear is low.

According to the disclosure, an actuator assembly for a vehicle brake, for example an electromechanical parking brake, having a carrier assembly, which comprises a first transmission plate and a second transmission plate, wherein the two transmission plates are connected to one another via a carrier component, are mounted in an actuator housing and carry a transmission unit, wherein the first transmission plate has a fastening interface for an electric motor and is mounted in an elastically damped manner on the carrier component, and the second transmission plate is rigidly coupled to the carrier component.

The transmission plates are consequently decoupled from one another. The first transmission plate, mounted in a damped manner, is suitable for damping vibrations of an electric motor and thus reducing drive noises. In other words, an electric motor can be elastically suspended from the first transmission plate.

The second, rigidly mounted transmission plate serves to absorb reaction forces of the brake piston which would otherwise act on the electric motor, for example, torques.

The transmission unit comprises at least one cylindrical gear stage, an intermediate transmission and a planetary transmission. It is thereby possible to achieve a required reduction ratio, which can be, for example, between 100:1 and 400:1.

According to one aspect, at least one bearing journal for a gear wheel is arranged on the carrier component, and the first transmission plate and the carrier component and/or the second transmission plate and the carrier component are aligned with respect to one another, connected to one another, by the at least one bearing journal. The bearing journal, which is present in any case, thus performs a dual function, as a result of which it is possible to dispense with additional alignment elements or connecting elements. This contributes to a compact construction of the actuator assembly.

For example, a plurality of bearing journals connects the first transmission plate and the carrier component, and the bearing journals support gear wheels of an intermediate transmission between the motor and an output-side planetary transmission. By virtue of a plurality of bearing journals connecting the first transmission plate and the carrier component, the first transmission plate can be aligned in a defined position on the carrier component. Moreover, it is additionally possible to dissipate forces via the bearing journals which support the gears of the intermediate transmission.

For example, at least one elastic arm is formed on the first transmission plate, and the first transmission plate is coupled to the carrier component via the at least one elastic arm. The elastic arm thus ensures decoupling between the first transmission plate and the second transmission plate. Moreover, the at least one elastic arm makes it possible for the first transmission plate to oscillate a certain distance with the electric motor.

According to one aspect, a bearing eye, in which a bearing journal is accommodated, is formed on the free end of the at least one elastic arm. The bearing eye serves for simple alignment of the first transmission plate on the carrier component, on the bearing journal. Specifically, the bearing eye can be fitted over the bearing journal.

In one exemplary arrangement, the at least one elastic arm is formed integrally on the first transmission plate, the elasticity of the elastic arm being achieved by reduced material thickness.

The second transmission plate can rest against an end face of the carrier component and a bearing cover can rest against an opposite end face of the carrier component from the second transmission plate, wherein the bearing cover and the second transmission plate each have, a mutually corresponding connecting arrangement and are connected to one another in such a way that the second transmission plate is secured on the carrier component by the bearing cover. In other words, the carrier component is clamped between the second transmission plate and the bearing cover. In this way, the advantage is achieved that an already existing component can be used for fastening the second transmission plate on the carrier component and no separate fastening elements are required. The bearing cover serves, for the pre-mounting of the second transmission plate on the carrier component.

For example, the bearing cover and the second transmission plate are latched to one another. Thus, the second transmission plate, the carrier component and the bearing cover can be connected to one another by a simple plug connection.

According to one aspect, the carrier assembly is accommodated with positive engagement in the actuator housing by a shaft-hub connection. In this way, torques acting on the brake piston can be dissipated into the actuator housing via the carrier assembly.

The bearing cover is supported on the actuator housing, thus additionally enabling axial forces to be dissipated into the actuator housing via the bearing cover.

The second transmission plate is also supported on the actuator housing.

Consequently, a large proportion of the reaction forces which occur at the brake piston are already dissipated into the actuator housing in the region of the second transmission plate and are not transmitted as far as the electric motor.

A ring gear of the planetary transmission, for example, is integrated into the carrier component. In other words, the carrier component is formed in one piece with the ring gear of the planetary transmission. This likewise contributes to a compact construction of the actuator assembly.

Specifically, the ring gear of the planetary transmission has on its circumferential wall a radial extension on which the at least one bearing journal is arranged.

According to one exemplary arrangement, an electric motor is fastened to the first transmission plate, and the first transmission plate is mounted elastically in the actuator housing. For example, the transmission plate is supported in the actuator housing via damping elements. In this way, vibrations of the electric motor are damped.

In addition, the electric motor can also be supported in the actuator housing via damping elements.

### BRIEF DESCRIPTION OF DRAWINGS

Further advantages and features of the disclosure will be found in the following description and in the accompanying drawings, to which reference is made. In the drawings:

FIG. 1 shows an actuator assembly according to the disclosure in a side view,

FIG. 2 shows the actuator assembly from FIG. 1 in a plan view,

FIG. 3 shows the actuator assembly from FIGS. 1 and 2 in a perspective partial sectional illustration,

FIG. 4 shows a section along the line B-B in FIG. 1,

FIG. 5 shows a section along the line A-A in FIG. 2, and

FIG. 6 shows a section along the line C-C in FIG. 2.

### DETAILED DESCRIPTION

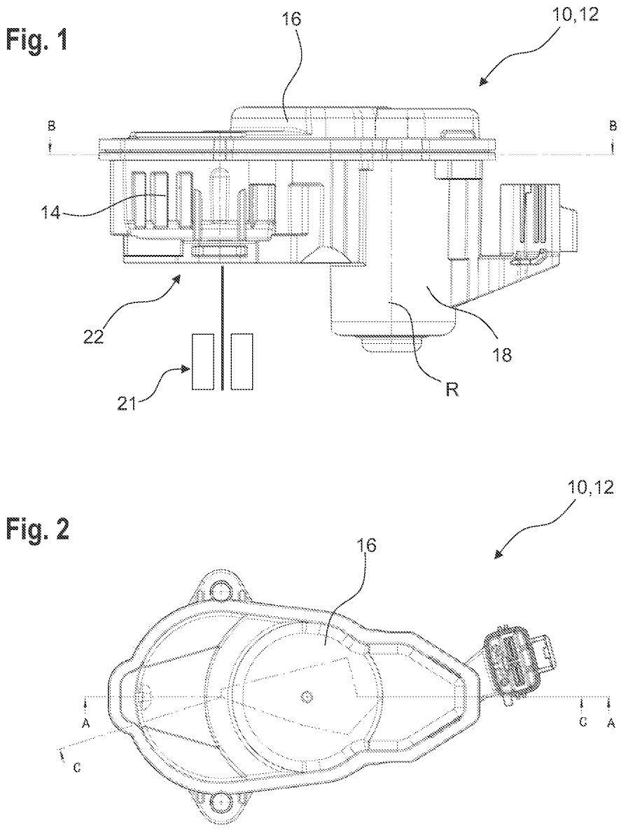

FIGS. 1 and 2 show an actuator assembly 10 in a side view and in a plan view, only one actuator housing 12 of the actuator assembly 10 being visible in FIGS. 1 and 2.

The actuator housing 12 has a shell-shaped part 14 and a housing cover 16.

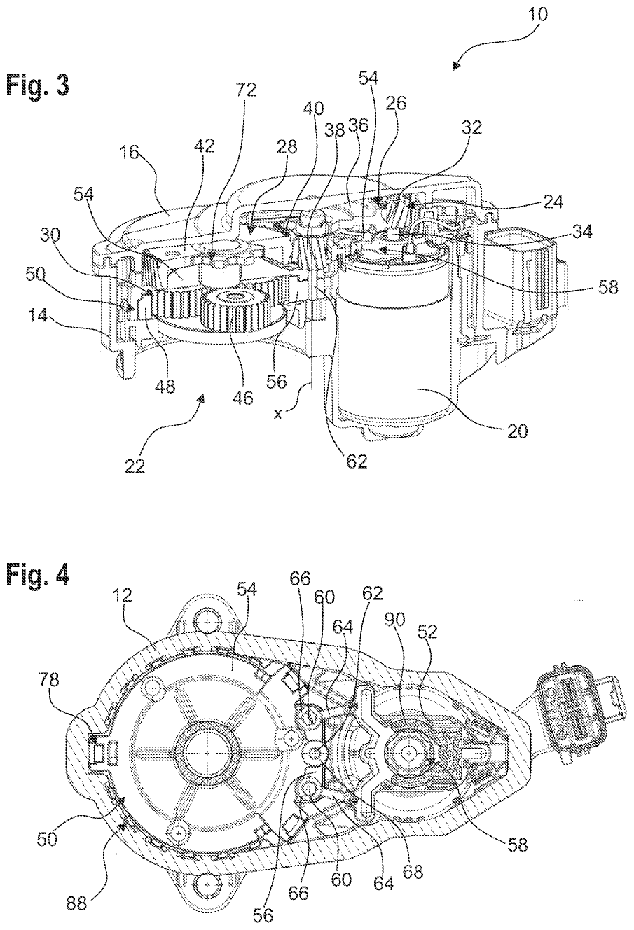

It can also be seen in FIG. 1 that the actuator housing 12 has an accommodation space 18 for an electric motor 20 (see FIG. 3).

In this case, an axis of rotation R of the electric motor 20 is parallel to a direction of movement of a brake piston, which is not illustrated in the figures for the sake of simplicity.

By way of example, the electric motor 20 drives a spindle drive 21 (illustrated schematically in FIG. 1), which moves the brake piston linearly.

The actuator housing 12 has a receptacle 22 for the spindle drive 21.

FIG. 3 shows a transmission unit 24, which couples the electric motor 20 to the spindle drive 21, a reduction ratio of between 120:1 and 200:1 being achieved.

The transmission unit 24 comprises a cylindrical gear stage 26, an intermediate transmission 28, and a planetary transmission 30.

The cylindrical gear stage 26 has a drive wheel 32, which is coupled to the electric motor 20 via a drive shaft 34 and is driven by the electric motor 20.

Furthermore, the cylindrical gear stage 26 comprises an end-side gear wheel 36, with which the drive wheel 32 is in mesh. Consequently, the gear wheel 36 is driven by the drive wheel 32.

A gear wheel 38, which is assigned to the intermediate transmission 28, is in turn coupled for conjoint rotation to the end-side gear wheel 36.

The end-side gear wheel 36 and gear wheel 38 have the same axis of rotation X. However, the gear wheel 38 of the intermediate transmission 28 has a smaller diameter than the gear wheel 36 of the cylindrical gear stage 26.

In one exemplary arrangement, the gear wheels 36, 38 are designed as double gear wheels.

In addition to gear wheel 38, the intermediate transmission 28 comprises two identically designed intermediate wheels 40 and an output wheel 42.

Gear wheel 38 meshes with both intermediate wheels 40 and drives them. FIG. 3 shows only one of the intermediate wheels 40.

The intermediate wheels 40 are in turn in mesh with the output wheel 42 and drive the output wheel 42.

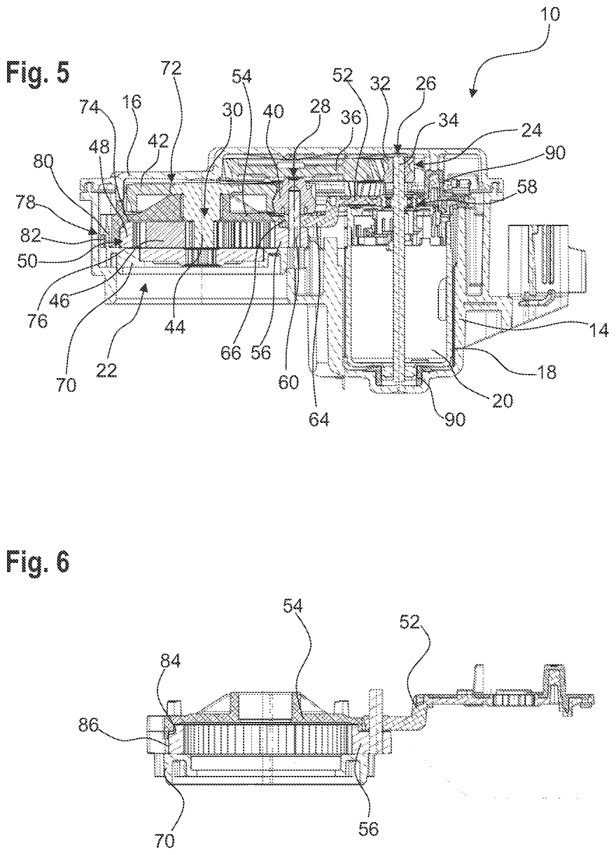

The output wheel 42 is coupled for conjoint rotation to a sun wheel 44 (see FIG. 5) of the planetary transmission 30, which comprises, in addition to the sun wheel 44, planet wheels 46 and a ring gear 48.

The spindle drive 21 of the actuator assembly 10 is driven by the planetary transmission 30.

Consequently, the transmission unit 24 couples the electric motor 20 in terms of drive to the spindle drive 21 of the actuator assembly 10 in order to move a brake piston linearly.

The transmission unit 24 is supported by a carrier assembly 50, which can be seen in FIGS. 3 to 6.

FIG. 4 shows a section through the actuator assembly 0 and a plan view of he carrier assembly 50.

The carrier assembly 50 comprises a first transmission plate 52 and a second transmission plate 54.

The two transmission plates 52, 54 are connected to one another via a carrier component 56, which in FIG. 4 is covered by the second transmission plate 54 and is only partially visible.

The ring gear 48 of the planetary transmission 30 is integrated into the carrier component 56, as can be seen in FIG. 3 and FIGS. 5 and 6.

The first transmission plate 52 has a fastening interface 58 for the electric motor 20.

A plurality of bearing journals 60, 62 is arranged on the carrier component 56.

The bearing journals 60, 62 support gear wheel 38 and the intermediate wheels 40 of the intermediate transmission 28.

In addition, the bearing journals 60, 62 serve to connect the first transmission plate 52 and the carrier component 56 as well as the second transmission plate 54 and the carrier component 56 to one another and to align them with one another.

More precisely, the first transmission plate 52 is fastened on the carrier component 56 by the bearing journals 60, which support the intermediate wheels 40. Fastening by way of two bearing journals 60 ensures that the first transmission plate 52 is simultaneously aligned in a defined position on the carrier component 56.

For the purpose of fastening on the carrier component 56, two elastic arms 64 are formed on the first transmission plate 52, and the first transmission plate 52 is coupled to the carrier component 56 via the elastic arms.

At the free end of each of the elastic arms 64, a bearing eye 66 is formed, the bearing journals 60 being accommodated in the bearing eyes 66.

By virtue of the fact that the first transmission plate 52 is fastened on the carrier component 56 by elastic arms, the first transmission plate 52 is mounted not rigidly but in an elastically damped manner on the carrier component 56. Thus, the first transmission plate 52 can oscillate with the electric motor 20 during operation.

As can be seen in FIG. 4, the first transmission plate 52 is fork-shaped in plan view.

The second transmission plate 54, on the other hand, is rigidly coupled to the carrier component 56.

As can be seen in FIGS. 3 and 4, the second transmission plate 54 is fastened on the carrier component 56 by way of the bearing journal 62 which supports the gear wheel 38 of the intermediate gear 28.

For this purpose, a bearing eye 68 is likewise formed on the second transmission plate 54.

Moreover, the second transmission plate 54 is fastened on the carrier component 56 by a bearing cover 70. The bearing cover 70 covers a transmission chamber 72, in which the transmission unit 24 is accommodated, and separates this from the receptacle 22 for the spindle drive.

In this case, the second transmission plate 54 rests against an end face 74 of the carrier component 56 and the bearing cover 70 rests against an opposite end face 76 of the carrier component 56 from the second transmission plate 54.

The bearing cover 70 and the second transmission plate 54 each have a mutually corresponding connecting arrangement 78 and are connected to one another in such a way that the second transmission plate 54 is secured on the carrier component 56 by the bearing cover 70.

To be precise, in one exemplary arrangement, the bearing cover 70 has integrally formed latching noses 80, which are latched into corresponding recesses 82 in the second transmission plate 54.

FIGS. 3 and 5 show that the carrier component 56 is clamped between the bearing cover 70 and the second transmission plate 54.

In addition, the second transmission plate 54 is centred by its inner wall 84 on a circumferential wall 86 of the carrier component 56 (see FIG. 6).

The second transmission plate 54 is in turn clamped axially between the bearing cover 70 and the actuator housing 12, in particular the housing cover 16.

The bearing cover 70 is clamped axially between the actuator housing 12, in particular the shell-shaped part 14, and the second transmission plate 54 as well as the carrier component 56.

This means that the bearing cover 70, the carrier component 56 and the second transmission plate 54 are clamped axially in the actuator housing 12 between the shell-shaped part 14 and the housing cover 16. As a result, forces acting in the axial direction in the region of the second transmission plate 54 can be dissipated particularly well via the actuator housing 12.

1 In addition, the carrier assembly 50 is accommodated with positive engagement in the actuator housing 12 by a shaft-hub connection 88 (see FIG. 4). In the exemplary arrangement, the shaft-hub connection 88 is a splined shaft connection.

In particular, the shaft-hub connection 88 is formed between the carrier component 56 and the actuator housing 12.

Due to the shaft-hub connection 88, the carrier assembly 50 is accommodated non-rotatably in the actuator housing 12. It is thus possible for torques which are transmitted from the spindle drive to the transmission unit 24 to be dissipated via the actuator housing 12.

In order to additionally damp vibrations of the electric motor 20, the electric motor 20 is supported, on the one hand, directly and, on the other hand, via the first transmission plate 52 by additional damping elements 90, as can be seen in FIGS. 4 to 6. In one exemplary arrangement, the damping elements 90 are formed from a flexible material.

1. An actuator assembly for a vehicle brake, comprising a carrier assembly, which comprises a first transmission plate and a second transmission plate, wherein the two transmission plates are connected to one another via a carrier component, are mounted in an actuator housing and carry a transmission unit, wherein the first transmission plate has a fastening interface for an electric motor and is mounted in an elastically damped manner on the carrier component, and the second transmission plate is rigidly coupled to the carrier component.

2. The actuator assembly according to claim 1, wherein at least one bearing journal for a gear wheel is arranged on the carrier component, and the first transmission plate and the carrier component and/or the second transmission plate and the carrier component are aligned with respect to one another, by the at least one bearing journal.

3. The actuator assembly according to claim 2, wherein a plurality of bearing journals connects the first transmission plate and the carrier component, and the bearing journals support gear wheels of an intermediate transmission between the motor and an output-side planetary transmission.

4. The actuator assembly according to claim 1, wherein at least one elastic arm is formed on the first transmission plate, and the first transmission plate is coupled to the carrier component via the at least one elastic arm.

5. The actuator assembly according to claim 2, wherein a bearing eye, in which a bearing journal is accommodated, is formed on a free end of at least one elastic arm formed on the first transmission plate.

6. The actuator assembly according to claim 1, wherein the second transmission plate rests against an end face of the carrier component and a bearing cover rests against an opposite end face of the carrier component from the second transmission plate, wherein the bearing cover and the second transmission plate each have mutually corresponding connecting arrangements and are connected to one another in such a way that the second transmission plate is secured on the carrier component by the bearing cover.

7. The actuator according to claim 6, wherein the bearing cover and the second transmission plate are latched to one another.

8. The actuator assembly according to claim 1, wherein the carrier assembly is accommodated with positive engagement in the actuator housing by a shaft-hub connection.

9. The actuator assembly according to claim 1, wherein the actuator assembly comprises a planetary transmission, and a ring gear of the planetary transmission is integrated into the carrier component.

10. The actuator assembly according to claim 1, wherein an electric motor is fastened to the first transmission plate, and the first transmission plate is mounted elastically in the actuator housing.

11. The actuator assembly according to claim 1, wherein at least one bearing journal for a gear wheel is arranged on the carrier component, and the first transmission plate and the carrier component and/or the second transmission plate and the carrier component are connected to one another, by the at least one bearing journal.

12. The actuator assembly according to claim 11, wherein at least one elastic arm is formed on the first transmission plate, and the first transmission plate is coupled to the carrier component via the at least one elastic arm.

13. The actuator assembly according to claim 3 wherein a bearing eye, in which a bearing journal is accommodated, is formed on a free end of at least one elastic arm formed on the first transmission plate.

14. The actuator assembly according to claim 12, wherein the second transmission plate rests against an end face of the carrier component and a bearing cover rests against an opposite end face of the carrier component from the second transmission plate, wherein the bearing cover and the second transmission plate each have a mutually corresponding connecting arrangement and are connected to one another in such a way that the second transmission plate-is secured on the carrier component by the bearing cover.

15. The actuator assembly according to claim 11, wherein the carrier assembly is accommodated with positive engagement in the actuator housing by a shaft-hub connection.

16. The actuator assembly according to claim 15, wherein the actuator assembly comprises a planetary transmission, and a ring gear of the planetary transmission is integrated into the carrier component.

17. The actuator assembly according to claim 11, wherein an electric motor is fastened to the first transmission plate, and the first transmission plate is mounted elastically in the actuator housing.
